(19) United States
(12) Patent Application Publication
(10) Pub. No.: US 2024/0180301 A1
(43) Pub. Date: Jun. 6, 2024

(54) WRISTBAND FOR EARPHONE PLACEMENT

(71) Applicant: OXTI Pte Ltd, Singapore (SG)

(72) Inventor: CHIH-FENG HO, Singapore (SG)

(21) Appl. No.: 18/075,344

(22) Filed: Dec. 5, 2022

(51) Int. Cl. A44C 5/00; H04R 1/10

(52) U.S. Cl. CPC A44C 5/0007; H04R 1/1091; H04R 2460/17

(57) ABSTRACT

A wristband for earphone placement includes: a wristband body, provided with an absorbing portion, and being an elastic body that can be worn on a wrist or arm; and at least one earphone, an outer surface of the earphone provided with absorbed portion, and the absorbed portion and absorbing portion provided with complementary absorbents to absorb each other. When wearing the earphones and wristband of the present invention while exercising, if there is a sudden situation, for example, if a user has earache caused by wearing it for a long time, or if they need to take off the earphone for a short time to hear the external sound, and they need to take off the earphone temporarily, the absorbed portion on the earphone can then be absorbed by the absorbing portion on the wristband body, so as to achieve temporary earphone placement.

### (a) TECHNICAL FIELD OF THE INVENTION

The present invention relates to a wristband, and more particularly to a wristband for earphone placement.

### (b) DESCRIPTION OF THE PRIOR ART

Chinese Patent Publishing No. CN216418258U, titled “sports wristband based on intelligent sports data analysis software”, as shown in FIG. 1 of the document, is mainly provided with a water-absorbing pad and a rubber ring, and its main function is to block sweat, absorb sweat and provide protection.

With the rising trend of modern sports, more and more people wear wristbands. Many people choose to wear earphones (headphones) to listen to music during exercise to help them concentrate more, but if the earphone needs to be temporarily taken down for a while, the dedicated storage case for earphones must be taken out to store it, or it is directly placed in a clothes pocket. However, if the earphone needs to be taken out again to use after placed in the dedicated storage case for earphones, the cover thereof must be opened again, and it can then be taken out to use. However, in an efficient society that emphasizes quickness, simplicity and immediate use, it has become a problem. As for putting the earphone in a pocket, it is easy to fall out and roll to the ground, making it difficult to find and more likely to cause earphone failure. Therefore, there has never been a good place to temporarily store earphones quickly and easily.

### SUMMARY OF THE INVENTION

To overcome the above disadvantages, the present invention proposes a wristband for earphone placement, including: a wristband body, provided with an absorbing portion, and being a closed ring body and elastic body; and at least one earphone, an outer surface of the earphone provided with absorbed portion capable of being absorbed by the absorbing portion.

When the at least one earphone and the wristband of the present invention are worn while exercising, and if there is a sudden situation, a user needs to take the earphone down temporarily, they can place the absorbed portion on the earphone on the wristband to allow it to be absorbed by the absorbing portion, so as to achieve an earphone placement effect.

### BRIEF DESCRIPTION OF THE DRAWINGS

FIG. 1 is an exploded view of the present invention;

FIG. 2 is a perspective view of the present invention;

FIG. 3 is a schematic view of the present invention worn on a wrist; and

FIG. 4 is a schematic view of the present invention worn on an arm.

### DETAILED DESCRIPTION OF THE PREFERRED EMBODIMENTS

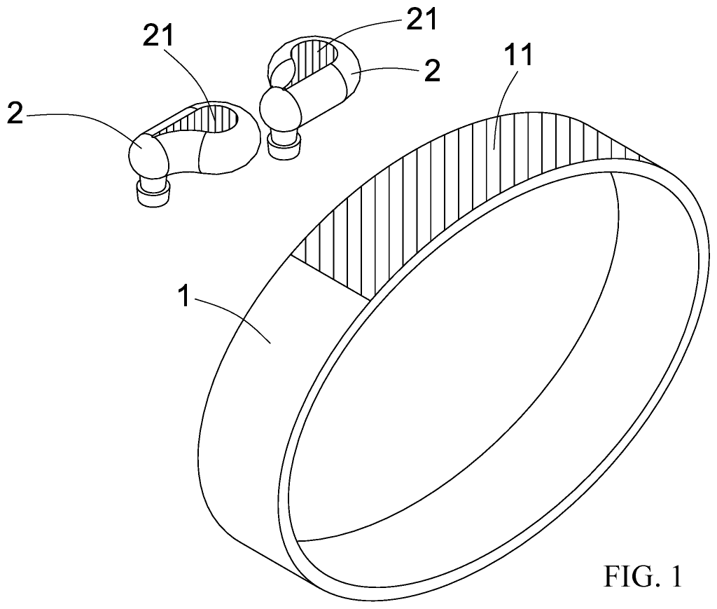

Referring to FIG. 1, a wristband for earphone placement of the present invention includes a wristband body 1, and at least one earphone 2.

The wristband body 1 is provided with an absorbing portion 11, and the wristband body 1 is a closed ring body and elastic body.

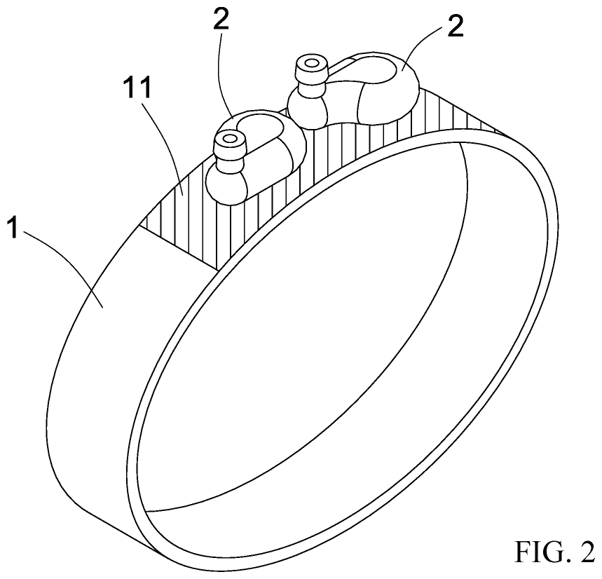

The earphone 2 is provided an absorbed portion 21 on the outer surface thereof; the absorbed portion 21 and absorbing portion 11 are provided with complementary absorbents to absorb each other, as shown in FIG. 2.

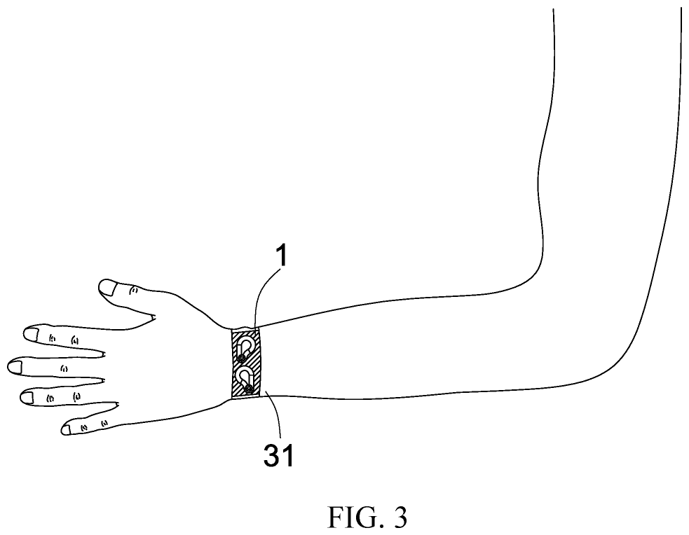

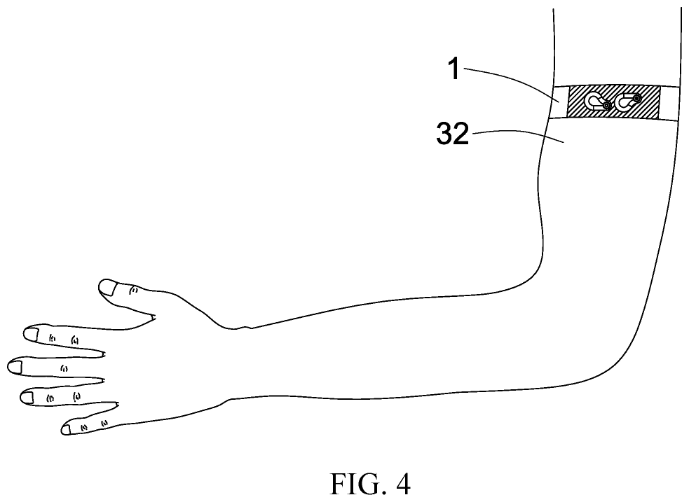

Referring to FIGS. 3 and 4, the wristband body 1 can be worn on a wrist 31 or arm 32.

Furthermore, the absorbed portion 21 and absorbing portion 11 are absorbed by each other by means of magnetic suction or Velcro tape. If it is magnetic suction, the absorbing portion 11 and absorbed portion 21 are provided with complementary magnetic parts, which can attract each other, if it is Velcro tape, the absorbing portion 11 and absorbed portion 21 are provided with Velcro tapes stuck to each other.

When listening to music while exercising, if there is a sudden situation, for example, if a user has earache caused by wearing it for a long time, or if they need to take off the earphone for a short time to hear the external sound, they need to take off the earphone 2 temporarily and can then be placed on the wristband body 1, which can obtain the space where the earphones can be temporarily placed, and also can be fast, simple, efficient, and not easy to drop when the earphone is stored or taken to use.

I claim:

1. A wristband for earphone placement, comprising:
a wristband body, provided with an absorbing portion, and being a closed ring; and
at least one earphone, an outer surface of said earphone provided with an absorbed portion capable of being absorbed by said absorbing portion.

2. The wristband according to claim 1, wherein said absorbing portion is provided with a magnetic part complementary to said absorbed portion.

3. The wristband according to claim 1, wherein said wristband body is an elastic body.

4. The wristband according to claim 1, wherein said absorbing portion and absorbed portion are respectively provided with a Velcro tape.
